(19) United States
(12) Patent Application Publication
(10) Pub. No.: US 2010/0268838 A1
(43) Pub. Date: Oct. 21, 2010

(54) METHOD AND EQUIPMENT FOR MULTI MEDIA APPLICATION MANAGEMENT USING MULTI STREAMING OF SCTP AND TIMED RELIABILITY OF PR-SCTP

(75) Inventors: Yong-Geun Hong, Daejeon (KR); Jung Soo Park, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/743,041

(22) PCT Filed: Jun. 16, 2008
(86) PCT No.: PCT/KR2008/003373

§ 371 Date: May 14, 2010

(30) Foreign Application Priority Data
Nov. 16, 2007 (KR) 10-2007-0117112

(51) Int. Cl. G06F 15/16

(52) U.S. Cl. 709/231

(57) ABSTRACT

Disclosed is a method for multimedia application management using a multi-streaming function of a Stream Control Transmission Protocol (SCTP) and a timed reliability function of a Partial Reliable (PR)-SCTP. The method includes calculating a number of connection objects required for transmitting at least one multimedia information, generating at least one association and stream of the SCTP to correspond to the number of the calculated connection objects, classifying the multimedia information according to purpose, granting a lifetime value to the classified multimedia information; and transmitting, via an SCTP corresponding to the lifetime value from among the SCTPs, the multimedia information to which the lifetime value is granted.

### TECHNICAL FIELD

The present invention relates to a method and apparatus for multimedia application management using a multi-streaming function of a Stream Control Transmission Protocol (SCTP) and a timed reliability function of a Partial Reliable (PR)-SCTP, and more particularly, to a method and apparatus for multimedia application management using a multi-streaming function of a SCTP and a timed reliability function of a PR-SCTP which may determine a connection between multimedia information in multimedia applications.

This work was supported by the IT R&D program of MIC/IITA. [2007-P10-027, Development of Next Generation Network Standards for IPv6 based Mobility Support]

### BACKGROUND ART

Nowadays, along with the development of mobile communication technologies, service technologies providing media information have been rapidly developed.

The media information may be provided in a variety of schemes, such as using a transport layer protocol obtained by combining a Transmission Control Procedure (TCP) and a User Datagram Protocol (UDP) both of which provide multimedia information. In the multimedia applications, the TCP may be used for transmitting information requiring a reliability property, and the UDP may be used for transmitting information requiring a real-time property.

In terms of the transport layer, a new connection between the TCP and UDP may function to manage information required by an application layer for each time, and thereby the connection or disconnection frequently performed between the TCP and UDP may cause a reduction in the overall performance of the transport layer in the case of a relatively small amount of information to be virtually transmitted.

Also, as an amount of information to be transmitted by an application program increases, connections between a large number of the TCPs and UDPs are required to be determined and maintained. Accordingly, in the multimedia application in which many channels are present such as an Internet Protocol Television (IPTV), the existing scheme in which a connection between the TCP and UDP is differently determined depending on characteristics of information may be not an effective method.

### DISCLOSURE OF INVENTION

### Technical Goals

An aspect of the present invention provides a method for multimedia application management using a multi-streaming function of a Stream Control Transmission Protocol (SCTP) and a timed reliability function of a Partial Reliable (PR)-SCTP, which may effectively determine, release, maintain, and manage a connection between information.

An aspect of the present invention provides a method for multimedia application management using a multi-streaming function of an SCTP and a timed reliability function of PR-SCTP, which may divide streams using an SCTP association once determined in a multimedia application, thereby independently transmitting a variety of multimedia information.

An aspect of the present invention provides a method for multimedia application management using a multi-streaming function of an SCTP and a timed reliability function of PR-SCTP, which may assign lifetime values different from one another for each multimedia information, thereby implementing a transmission method which differs depending on characteristics and purposes of the multimedia information acquired due to segmentation in the lifetime values.

### Technical Solutions

According to an aspect of the present invention, there is provided a method for multimedia application management using a multi-streaming function of a Stream Control Transmission Protocol (SCTP) and a timed reliability function of a Partial Reliable (PR)-SCTP, the method including: calculating a number of connection objects required for transmitting at least one multimedia information; generating at least one association and stream of the SCTP to correspond to the number of the calculated connection objects; classifying the multimedia information according to purpose; granting a lifetime value to the classified multimedia information; and transmitting, via an SCTP corresponding to the lifetime value from among the SCTPs, the multimedia information to which the lifetime value is granted.

In this instance, the method may further include: re-classifying the transmitted multimedia information according to purpose; granting another lifetime value to the re-classified multimedia information; and transmitting, via the SCTP corresponding to the lifetime value from among the SCTPs, the multimedia information to which the other lifetime value is granted.

According to an aspect of the present invention, there is provided an apparatus for multimedia application management using multi-streaming of an SCTP and timed reliability of a PR-SCTP, the apparatus including: a calculation unit to calculate a number of connection objects required for transmitting at least one multimedia information; an SCTP generation unit to generate at least one association and stream of the SCTP to correspond to the number of the calculated connection objects; a classification unit to classify the multimedia information according to purpose; a lifetime matching unit to grant a lifetime value to the classified multimedia information; and an information transmission unit to transmit, via an SCTP corresponding to the lifetime value from among the SCTPs, the multimedia information to which the lifetime value is granted.

In this instance, the multimedia information may be re-classified while transmitting the multimedia information, and another lifetime value may be granted to the re-classified information.

### BRIEF DESCRIPTION OF DRAWINGS

FIG. 1 illustrates a structure of a Stream Control Transmission Protocol (SCTP) according to an exemplary embodiment of the invention;

FIG. 2 illustrates a structure of a multi-streaming of an SCTP according to an exemplary embodiment of the invention;

FIG. 3 is a block diagram illustrating a configuration of a multimedia application management apparatus using a multi-streaming function of an SCTP and a timed reliability function of a PR-SCTP according to an exemplary embodiment of the invention;

FIG. 4 illustrates a table classifying segmented multimedia information according to an exemplary embodiment of the invention;

FIG. 5 illustrates a table in which a timed reliability is granted to segmented multimedia information according to an exemplary embodiment of the invention;

FIG. 6 is a flowchart illustrating a multimedia application management method using a multi-streaming function of an SCTP and a timed reliability function of a PR-SCTP according to an exemplary embodiment of the invention; and

FIG. 7 is a flowchart illustrating a method in which multimedia information being currently transmitted is re-classified through a multimedia application management method using a multi-streaming function of an SCTP and a timed reliability function of a PR-SCTP according to an exemplary embodiment of the invention, and the re-classified multimedia information is re-transmitted.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

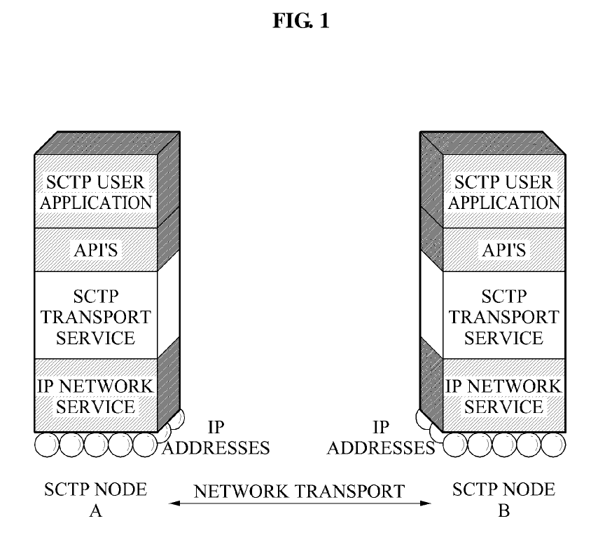

FIG. 1 illustrates a structure of a Stream Control Transmission Protocol (SCTP) according to an exemplary embodiment of the invention.

A multimedia application management apparatus 100 according to the present exemplary embodiment of the invention provides a structure for transmitting/receiving multimedia information via the SCTP.

As illustrated in FIG. 1, the SCTP of the present exemplary embodiment of the invention is positioned between an application layer and a network layer, and receives application information between SCTP peers through an Application Programming Interfaces (APIs) and transmits the received application information via an Internet Protocol (IP) network.

In this instance, the SCTP uses a multiple path function and multi-streaming function for message transmission between two SCTP portions, and an SCTP connection between two SCTP portions is referred to as ‘SCTP association’. Specifically, an association of the SCTP denotes a connection path between at least one SCTPs.

Also, the SCTP of the present exemplary embodiment of the invention has multi-streaming characteristics, and may control an SCTP session to simultaneously use a plurality of IP addresses.

In this instance, the SCTP may maintain the SCTP session via an alternate path or an alternate IP address in the case of occurrence of a network failure during the SCTP session. The SCTP peers may exchange an available IP address list with one other in a step of initialization of the SCTP session, and may determine a primary IP address in the available IP address list.

Also, another SCTP transmits information via the primary IP address acting as a receiving address, and automatically converts the primary IP address into another alternate IP address to thereby maintain the information transmission when the primary address is determined to have abnormality by SCTP path management.

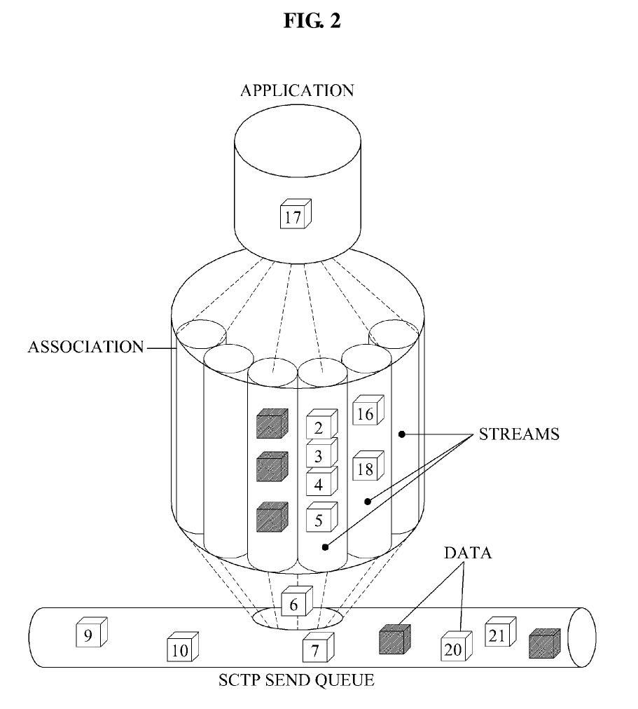

FIG. 2 illustrates a structure of a multi-streaming of an SCTP according to an exemplary embodiment of the invention.

The SCTP according to the present exemplary embodiment of the invention may transmit a variety of application information via a signal session as illustrated in FIG. 2, and a sender may inform a receiver of a number of streams to be sent in the step of initialization of the session, so that an independent ordering function may be provided for each stream in a transmission step.

Also, a Partial Reliable (PR)-SCTP used in the present exemplary embodiment of the invention is an expansion of the SCTP in which a function of ‘partially ensuring reliability’ is added to a basic standard of the SCTP, and may grant a lifetime value to an application message and accordingly may partially ensure the reliability, and thus enabling to provide a real-time application using the SCTP.

The PR-SCTP may use all functions defined in the basic standard of the SCTP, and support timed reliability services, thereby partially ensuring the reliability.

Also, 65,536 one-way streams may be generated in the single SCTP association, and these streams may simultaneously transmit a great amount of information.

In this instance, these streams are required to be set interactive in order to transmit reliable information, and thereby 32,768 streams capable of transmitting the reliable information may be used.

Specifically, only the single SCTP association may process a variety of multimedia information required in the multimedia application using the multiple-streaming. However, according to the present exemplary embodiment of the invention, at least one SCTP association is provided, thereby transmitting/receiving a huge amount of multimedia information.

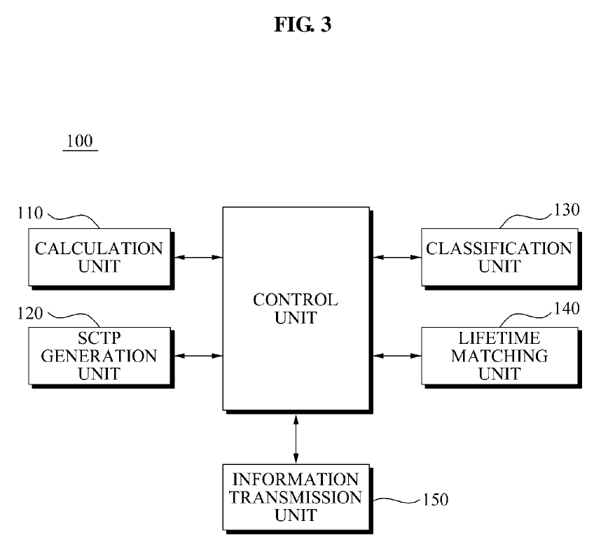

FIG. 3 is a block diagram illustrating a configuration of a multimedia application management apparatus 100 using a multi-streaming function of an SCTP and a timed reliability function of a PR-SCTP according to the present exemplary embodiment of the invention.

A configuration of an apparatus for transmitting/receiving the multimedia information using the above-described SCTP and PR-SCTP will be herein described in detail to correspond to a method for transmitting the multimedia information.

First, a calculation unit 110 calculates a number of connection objects required for transmitting at least one multimedia information.

The multimedia application management apparatus 100 according to the present exemplary embodiment of the invention calculates, in advance, the number of connection objects needed according to characteristics and purposes of the multimedia information. In this instance, the multimedia information is required to be transmitted by the multimedia application at every necessary time at the time of execution of an application program.

Specifically, the calculation unit 110 calculates a number of the SCTP associations and streams according to characteristics and purposes of the multimedia information.

Next, the SCTP generation unit 120 generates at least one association and stream of the SCTP to correspond to the calculated connection objects.

In this instance, the calculation unit 110 may be expected to transmit a greater amount of multimedia information due to 65,536 one-way streams generated in the single SCTP association. However, the calculation unit 110 may calculate the number of the connection objects used for transmitting information requiring a reliability property and information requiring a real-time property, respectively, and the SCTP generation unit 120 may generate at least two associations and streams of the SCTP, that is, the connection object calculated by the calculation unit 110.

Next, the classification unit 130 classifies the multimedia information according to the purpose.

According to the present exemplary embodiment of the invention, whether the multimedia information having a variety of purposes and characteristics is information to be transmitted requiring either the reliability property or the real-time property may be determined.

In this instance, the multimedia information may require a relatively high real-time property or a relatively low real-time property. Also, from among the multimedia information requiring the reliability property, there exists multimedia information to be inevitably transmitted and multimedia information not need to be transmitted at the time of transmission failure even after retrying several times for the transmission.

Specifically, the classification unit 130 determines presence/absence of the reliability property and the real-time property based on the purpose of the multimedia information, and segments the classification according to a specific division.

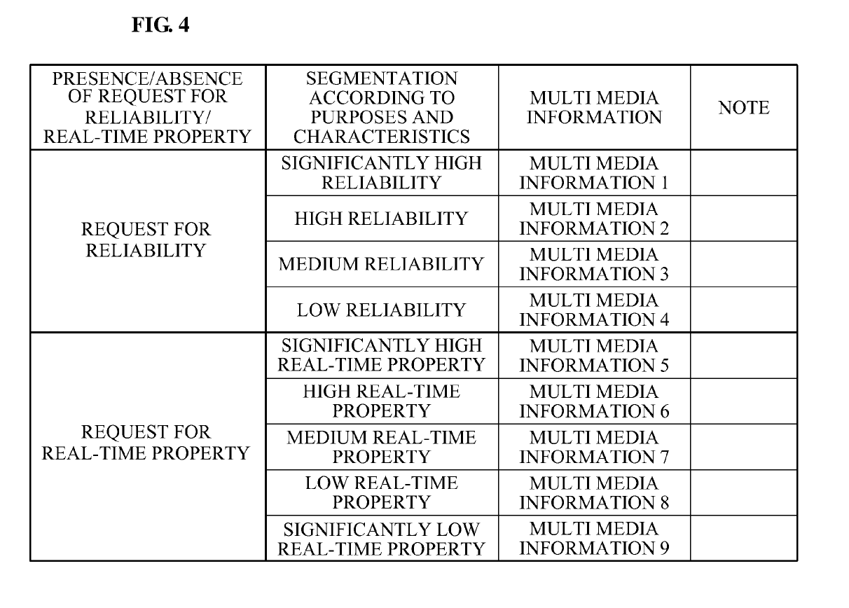

FIG. 4 illustrates a table classifying the segmented multimedia information according to an exemplary embodiment of the invention.

As illustrated in FIG. 4, the present invention may classify, in a more segmented fashion, the multimedia information having a variety of purposes and characteristics using the multi-streaming function of the SCTP and the timed reliability function of the PR-SCTP.

Specifically, the present invention may classify the multimedia information into information requiring the reliability property and information requiring the real-time property, and further classify the information requiring the reliability property according to a degree of the reliability property in a more segmented fashion.

Accordingly, the present invention may segment and classify the above-described variety of multimedia information in a transmission layer where the SCTP is located without a separate operation of another mechanism or in an application layer using the timed reliability function of the PR-SCTP.

Next, a lifetime matching unit 140 grants a lifetime value to the classified multimedia information.

In this instance, the lifetime matching unit 140 assigns the lifetime value to the classified multimedia information using the timed reliability function of the PR-SCTP.

Here, the timed reliability function of the PR-SCTP applied in the present invention denotes a service in which a lifetime is assigned to multimedia information received from the application layer to thereby ensure the reliability property only during the assigned lifetime. Also, the present invention may perform a real-time service in which multimedia information is not re-transmitted during another lifetime other than the assigned lifetime.

Specifically, the present invention may ensure the reliability property only during the assigned lifetime, and thereby appropriate assignment of the lifetime may enable the multimedia information to be classified into information requiring the reliability property and information requiring the real-time property to thereby be transmitted.

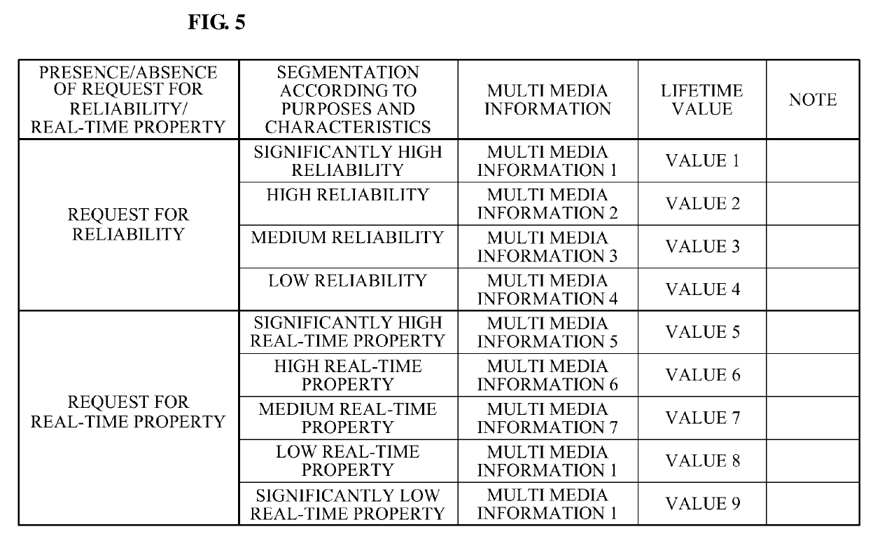

FIG. 5 illustrates a table where a timed reliability is granted to segmented multimedia information according to an exemplary embodiment of the invention.

As illustrated in FIG. 5, the present invention may segment the lifetime and grant a corresponding lifetime value for each of the classified multimedia information, thereby differently transmitting the multimedia information depending on the reliability property and the real-time property.

Next, an information transmission unit 150 transmits the multimedia information to which the lifetime value is granted via an SCTP corresponding to the lifetime from among the SCTPs.

The information transmission unit 150 loads a variety of multimedia information received from a multimedia application layer on SCTP packets having different timed reliability, and transmits the loaded information to the corresponding side.

In this instance, an interface of a transmitter of the SCTP is defined as SEND (association id, buffer address, byte count [,context] [, stream id] [,life time] [,destination transport address] [,unorder flag] [,no-bundle flag] [,payload protocol-id]) in an IETF RFC 2960 10.1(E) used in the present invention.

Also, the multimedia application management apparatus 100 according to the present invention may re-classify the multimedia information while transmitting the multimedia information, and grant a lifetime value corresponding to the re-classified multimedia information.

Specifically, when the timed reliability according to the classified multimedia information is required to be re-set in a lifetime field value, and a transmission rule of the multimedia information being currently transmitted is required to be changed, the lifetime value is changed using the classification unit 130 and the lifetime matching unit 140, and the multimedia information is loaded on the SCTP packet and transmitted.

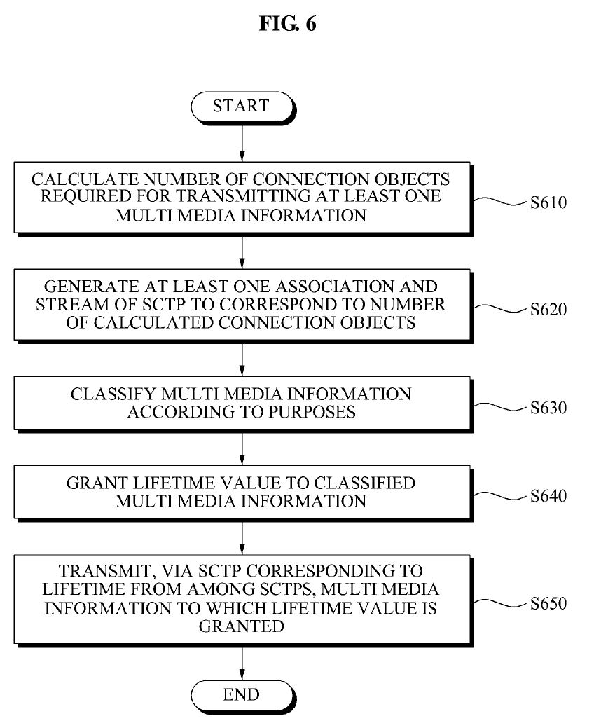

FIG. 6 is a flowchart illustrating a multimedia application management method using a multi-streaming function of an SCTP and a timed reliability function of a PR-SCTP.

As illustrated in FIG. 6, the multimedia information may be loaded on the SCTP packet to be transmitted using the multimedia application management apparatus 100, which will be herein described in detail referring to the above-descriptions.

In this instance, the multimedia application management method may correspond to a method for executing the multimedia application management apparatus 100 according to the present exemplary embodiment of the invention, and therefore may include the above-described explanations of the multimedia application management apparatus.

In operation S610, the calculation unit 110 calculates a number of connection objects required for transmitting at least one multimedia information.

Specifically, in operation S610, a number of SCTP associations and streams of the needed connection objects may be calculated in advance according to characteristics and purposes of the multimedia information using the multimedia application management apparatus 100.

In operation S620, the SCTP generation unit 120 generates at least one association and stream of the SCTP to correspond to the calculated number of the connection objects.

In this instance, 65,536 one-way streams may be generated in a single SCTP association to thereby transmit a great amount of multimedia information, however, the SCTP generation unit 120 may generate at least two associations and streams of the SCTP, that is, the connection object, when a much greater amount of multimedia information is required to be transmitted.

In operation S630, the classification unit 130 classifies the multimedia information according to the purpose.

Specifically, in operation S630, the reliability property and the real-time property are determined according to the purpose of the multimedia information using the classification unit 130, and segments the classification according to a specific section.

In operation S640, the lifetime matching unit 140 grants a lifetime value to the classified multimedia information.

Specifically, in operation S640, the lifetime value may be granted to the classified multimedia information based on the timed reliability function of the PR-SCTP using the lifetime matching unit 140.

In operation S650, the information transmission unit 150 transmits the multimedia information to which the lifetime value is granted via the SCTP corresponding to the lifetime from among the SCTPs.

Specifically, in operation S650, a variety of multimedia information received from the multimedia application layer is loaded on the SCTP packet having a timed reliability different from each other using the information transmission unit 150, and transmitted to the corresponding side.

The multimedia application management apparatus 100 may re-classify the multimedia information while transmitting the multimedia information, and grant a corresponding lifetime value to the re-classified multimedia information.

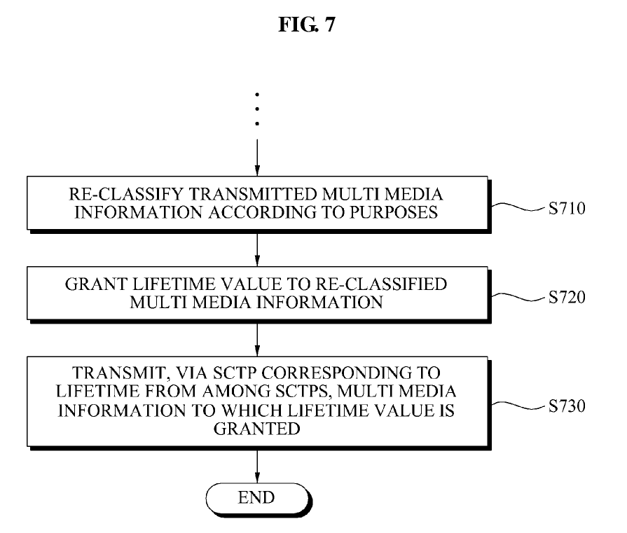

FIG. 7 is a flowchart illustrating a method in which multimedia information being currently transmitted is re-classified through a multimedia application management method using a multi-streaming function of an SCTP and a timed reliability function of a PR-SCTP according to an exemplary embodiment of the invention, and the re-classified multimedia information is re-transmitted.

As illustrated in FIG. 7, in operation S710, when the multimedia information is required to be re-classified and re-transmitted, the classification unit 130 re-classifies the multimedia information being currently transmitted according to the purpose.

In operation S720, the lifetime matching unit 140 grants a lifetime value to the re-classified multimedia information.

In operation S730, the information transmission unit 150 transmits the multimedia information to which the lifetime value is granted via the SCTP corresponding to the lifetime from among the SCTPs.

The multimedia application management method according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according to exemplary embodiments of the present invention, a connection between information may be effectively determined, released, maintained, and managed using a multi-streaming function of an SCTP and a timed reliability function of PR-SCTP.

According to exemplary embodiments of the invention, streams are divided using an SCTP association once determined in a multimedia application, thereby independently transmitting a variety of multimedia information.

According to exemplary embodiments of the invention, lifetime values different from one another are assigned for each multimedia information, thereby implementing a transmission method which differs depending on characteristics and purposes of the multimedia information acquired due to segmentation in the lifetime values.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for multimedia application management using a multi-streaming function of a Stream Control Transmission Protocol (SCTP) and a timed reliability function of a Partial Reliable (PR)-SCTP, the method comprising:
calculating a number of connection objects required for transmitting at least one multimedia information;
generating at least one association and stream of the SCTP to correspond to the number of the calculated connection objects;
classifying the multimedia information according to purpose;
granting a lifetime value to the classified multimedia information; and
transmitting, via an SCTP corresponding to the lifetime value from among the SCTPs, the multimedia information to which the lifetime value is granted.

2. The method of claim 1, wherein the association of the SCTP is a connection path between the at least one SCTP.

3. The method of claim 1, wherein the at least one SCTP transmits the multimedia information using multiple path and multi-streaming functions.

4. The method of claim 1, wherein the SCTP association includes 65,536 streams.

5. The method of claim 1, wherein the classifying determines presence/absence of a reliability property and a real-time property based on the purpose of the multimedia information, and segments classification according to a specific division.

6. The method of claim 1, wherein the granting assigns the lifetime value using the timed reliability function of the PR-SCTP.

7. The method of claim 1, further comprising:
re-classifying the transmitted multimedia information according to purpose; granting another lifetime value to the re-classified multimedia information; and
transmitting, via the SCTP corresponding to the lifetime value from among the SCTPs, the multimedia information to which the other lifetime value is granted.

8. A computer-readable recording medium storing a program for implementing the method of claim 1.

9. An apparatus for multimedia application management using multi-streaming of an SCTP and timed reliability of a PR-SCTP, the apparatus comprising:
a calculation unit to calculate a number of connection objects required for transmitting at least one multimedia information;
an SCTP generation unit to generate at least one association and stream of the SCTP to correspond to the number of the calculated connection objects;
a classification unit to classify the multimedia information according to purpose;
a lifetime matching unit to grant a lifetime value to the classified multimedia information; and
an information transmission unit to transmit, via an SCTP corresponding to the lifetime value from among the SCTPs, the multimedia information to which the lifetime value is granted.

10. The apparatus of claim 9, wherein the SCTP association is a connection path between the at least one SCTP.

11. The apparatus of claim 9, wherein the at least one SCTP transmits the multimedia information using multiple path and multi-streaming functions.

12. The apparatus of claim 9, wherein the SCTP association includes 65,536 streams.

13. The apparatus of claim 9, wherein the classification unit determines presence/absence of a reliability and a real-time property based on the purpose of the multimedia information, and segments classification according to a specific division.

14. The apparatus of claim 9, wherein the lifetime matching unit assigns the lifetime value using the timed reliability function of the PR-SCTP.

15. The apparatus of claim 9, wherein the multimedia information is re-classified while transmitting the multimedia information, and another lifetime value is granted to the re-classified information.
